(19) United States
(12) Patent Application Publication
(10) Pub. No.: US 2012/0038471 A1
(43) Pub. Date: Feb. 16, 2012

(54) Haptic feedback actuator, haptic feedback device and electronic device

(75) Inventors: Boum Seock Kim, Suwon (KR); Seung Gyo Jeong, Hwaseong (KR); Eun Tae Park, Yongin (KR)

(73) Assignee: SAMSUNG ELECTRO-MECHANICS CO., LTD., Suwon (KR)

(21) Appl. No.: 12/926,800

(22) Filed: Dec. 9, 2010

(30) Foreign Application Priority Data
Aug. 13, 2010 (KR) 10-2010-0078169

(51) Int. Cl. G08B 6/00

(52) U.S. Cl. 340/407.2; 340/407.1

(57) ABSTRACT

There is provided a haptic feedback actuator, a haptic feedback device and an electronic device. The haptic feedback actuator includes a support plate disposed in a lower portion of a haptic device; one or more actuators disposed on the support plate, each having one end towards a central portion of the support plate and the other end towards a corner of the support plate, and generating vibrations so as to give different types of haptic feedback according to a change in contact pressure applied to the haptic device; and one or more dividing portions, each penetrating the support plate in a thickness direction thereof and dividing the support plate into vibration areas corresponding to the respective actuators.

### CROSS-REFERENCE TO RELATED APPLICATIONS

This application claims the priority of Korean Patent Application No. 10-2010-0078169 filed on Aug. 13, 2010, in the Korean Intellectual Property Office, the disclosure of which is incorporated herein by reference.

### BACKGROUND OF THE INVENTION

1. Field of the Invention

The present invention relates to a haptic feedback actuator, a haptic feedback device, and an electronic device, and more particularly, to a haptic feedback actuator, a haptic feedback device and an electronic device that can provide high vibration intensity and uniform haptic feedback.

2. Description of the Related Art

Recently, the use of touch-type devices allowing for an inputting operation in electronic devices (or home appliances) through a touch (contact) operation has become generalized according to the demands of users who desire to use electronic appliances in a simpler manner.

Currently, a haptic feedback device follows the concept of providing an intuitive user interface experience and diversifying possible types of contact feedback, in addition to facilitating the concept of performing an inputting operation through touch.

The haptic feedback device has many advantages: it can save space, accomplish an improvement in manipulation and simplicity, allow for a simple change in specification, have a high level of user recognition, and have good interworkability with IT devices.

With such advantages, the haptic feedback device is commonly employed in electronic devices used in computers, traffic note issuing devices, public information services, medical equipment, mobile communications devices, and the like. In such electronic devices, a vibration motor has been employed as an actuator for implementing a haptic function. However, the vibration motor has a low reaction rate to a rapid touch. In order to increase the reaction rate, the use of a piezo actuator has been proposed.

A piezo-type haptic feedback device is configured in a manner such that a piezo actuator is fixed to a plate formed of steel use stainless (SUS) by applying an adhesive to a lower surface of the piezo actuator; the piezo actuator vibrates vertically when voltage is applied thereto; the vibrations of the piezo actuator are transferred to a touch panel disposed on an upper portion of the piezo actuator; and various types of haptic feedback are provided.

In the case of bar-shaped piezo actuators, they are generally arranged in both sides of the plate in order to minimize the influence of vibrations between the actuators.

In this case, however, the haptic feedback transferred to a user according to a position of a touch panel touched by the user is not uniform. That is, in terms of reaction rate and vibration intensity, in the case in which a portion of the touch panel, adjacent to the actuator, is touched by the user, the actuator provides a high speed reaction and high vibration intensity. However, in the case in which a portion of the touch panel, relatively distant from the actuator, is touched by the user, the reaction rate and vibration intensity of the actuator are reduced. Such non-uniform haptic feedback is most apparent in a central portion of the touch panel.

### SUMMARY OF THE INVENTION

An aspect of the present invention provides a haptic feedback actuator, a haptic feedback device and an electronic device that can provide high vibration intensity and uniform haptic feedback.

According to an aspect of the present invention, there is provided a haptic feedback actuator including: a support plate disposed in a lower portion of a haptic device; one or more actuators disposed on the support plate, each having one end towards a central portion of the support plate and the other end towards a corner of the support plate, and generating vibrations so as to give different types of haptic feedback according to a change in contact pressure applied to the haptic device; and one or more dividing portions, each penetrating the support plate in a thickness direction thereof and dividing the support plate into vibration areas corresponding to the respective actuators.

The one or more dividing portions may be configured as slits, each having one end towards the central portion of the support plate and the other end towards a side of the support plate.

The support plate may be configured as a rectangular frame including diagonal branch lines, and the one or more actuators may be adhered to the branch lines.

The one or more dividing portions may be opening portions between the branch lines.

The one or more actuators may be piezo actuators, each being configured as a bar-shaped ceramic stacked body including ceramic layers and an electrode interposed between the ceramic layers.

According to another aspect of the present invention, there is provided a haptic feedback device including: a display panel provided as a haptic device in which vibrations are required; a support plate disposed in a lower portion of the display panel; one or more actuators disposed on the support plate, each having one end towards a central portion of the support plate and the other end towards a corner of the support plate, and generating vibrations so as to give different types of haptic feedback according to a change in contact pressure applied to the display panel; and one or more dividing portions, each penetrating the support plate in a thickness direction thereof and dividing the support plate into vibration areas corresponding to the respective actuators.

The one or more dividing portions may be configured as slits, each having one end towards the central portion of the support plate and the other end towards a side of the support plate.

The support plate may be configured as a rectangular frame including diagonal branch lines, and the one or more actuators may be adhered to the branch lines.

The one or more dividing portions may be opening portions between the branch lines.

The one or more actuators may be piezo actuators, each being configured as a bar-shaped ceramic stacked body including ceramic layers and an electrode interposed between the ceramic layers.

The haptic feedback device may further include a vibration plate disposed between the display panel and the one or more actuators and amplifying the vibrations generated in the one or more actuators to thereby transfer the amplified vibrations to the display panel.

According to another aspect of the present invention, there is provided an electronic device including: a case having an internal space formed therein; a display panel accommodated to be disposed within the case; a support plate disposed in a lower portion of the display panel; one or more actuators disposed on the support plate, each having one end towards a central portion of the support plate and the other end towards a corner of the support plate, and generating vibrations so as to give different types of haptic feedback according to a change in contact pressure applied to the display panel; and one or more slits, each penetrating the support plate in a thickness direction thereof and having one end towards the central portion of the support plate and the other end towards a side of the support plate in order to divide the support plate into vibration areas corresponding to the respective actuators.

The one or more actuators may be piezo actuators, each being configured as a bar-shaped ceramic stacked body including ceramic layers and an electrode interposed between the ceramic layers.

The electronic device may further include a vibration plate disposed between the display panel and the one or more actuators and amplifying the vibrations generated in the one or more actuators to thereby transfer the amplified vibrations to the display panel.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view of an electronic device according to an exemplary embodiment of the present invention;

FIG. 2 is an enlarged exploded view of a haptic feedback actuator according to an exemplary embodiment of the present invention;

FIG. 3 is a plan view of a haptic feedback actuator according to an exemplary embodiment of the present invention;

FIG. 4 is an enlarged exploded view of a haptic feedback actuator according to another exemplary embodiment of the present invention; and

FIG. 5 is a plan view of a haptic feedback actuator according to another exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like elements.

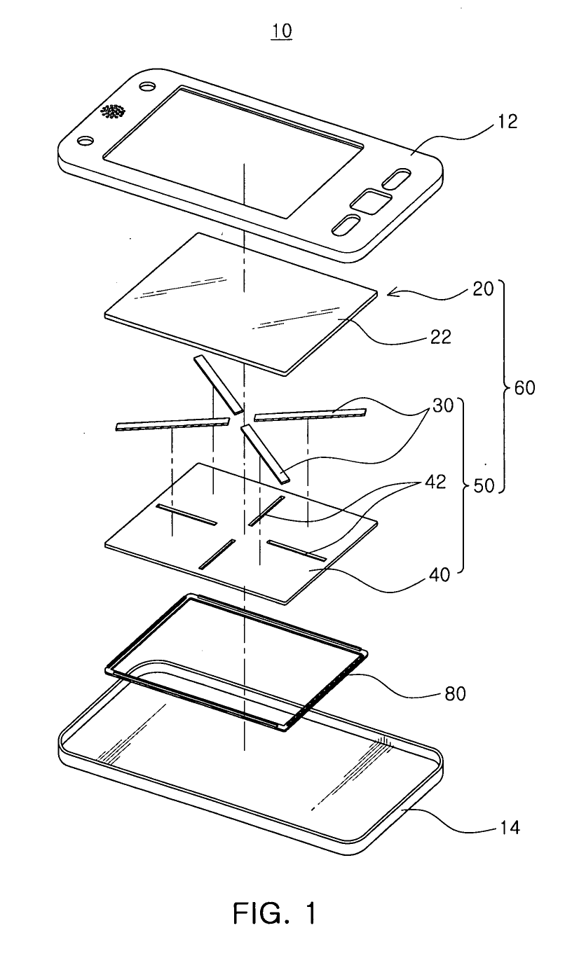

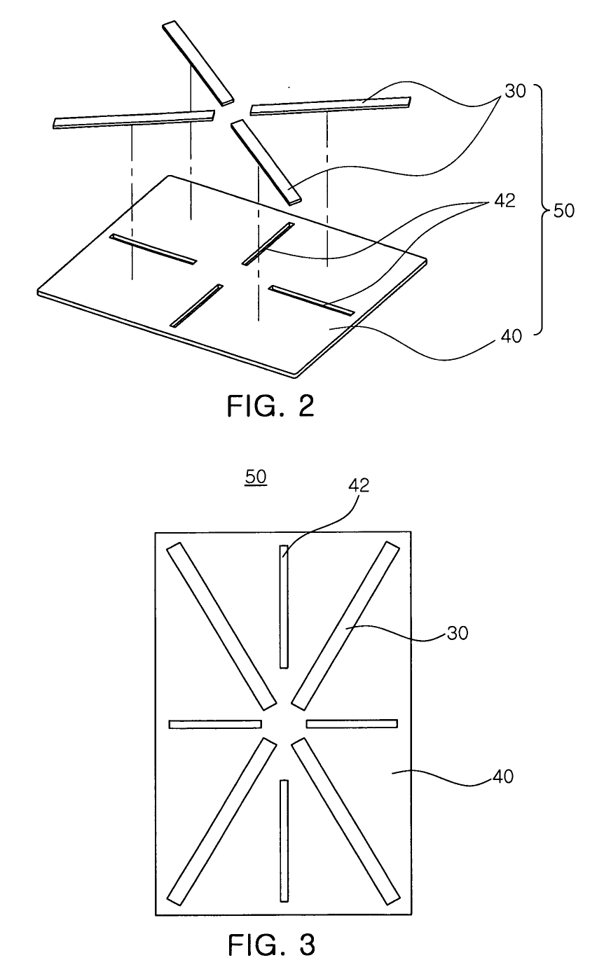

FIG. 1 is an exploded perspective view of an electronic device according to an exemplary embodiment of the present invention. FIG. 2 is an enlarged exploded view of a haptic feedback actuator according to an exemplary embodiment of the present invention. FIG. 3 is a plan view of a haptic feedback actuator according to an exemplary embodiment of the present invention.

In the following description, a mobile communications terminal 10 will be taken as an electronic device according to an exemplary embodiment of the invention, but without being limited thereto, the electronic device may be also applicable to a general haptic device generating a change in vibrations according to user contact with devices such as various OA devices, medical equipment, mobile communications devices, traffic note issuing devices, and the like.

Hereinafter, the mobile communications terminal 10 as an example of an electronic device will be described in detail.

With reference to FIG. 1, the mobile communications terminal 10, which is an electronic device according to an exemplary embodiment of the invention, may include a case 12 and 14 and a haptic feedback device 60.

The case 12 and 14 may include a front case portion 12 and a rear case portion 14. The front case portion 12 and the rear case portion 14 may be coupled to form an internal space therebetween.

The haptic feedback device 60 may be disposed in the internal space by being inserted into a rubber ring 80. A circuit board (not shown) that can drive a haptic feedback actuator 50 of the haptic feedback device 60 may be mounted in the internal space.

Here, the haptic feedback device 60 may include a haptic device 20 and the haptic feedback actuator 50.

In the mobile communications terminal 10 that is the electronic device according to the present embodiment, a display panel 22 providing an image is employed as the haptic device 20. Namely, when contact pressure is changed according to a contact applied to the display panel 22, the display panel 22 reacts haptically to the contact.

Besides the display panel 22 of the mobile communications terminal 10, the haptic device 20 may also be an input device that requires a reaction upon contact pressure, e.g., an OA device, a vending machine, a ticketing machine, or the like.

The display panel 22 may include a touch screen panel (not shown) and an image display portion (not shown). The touch screen panel formed on an outer surface of the display panel 22 is formed by stacking an outer film layer, an indium tin oxide (ITO) film layer and a base film layer.

Also, the image display portion is disposed on a bottom surface of the touch screen panel. The image display portion emits light to a front surface of the mobile communications terminal 10. At this time, one of a liquid crystal display (LCD), a plasma display panel (PDP) and an electroluminescence (EL) display may be selectively employed as the image display portion. However, the image display portion is not limited thereto.

The haptic feedback actuator 50 may include an actuator 30 and a support plate 40. Also, the haptic feedback device 60 may include the display panel 22 receiving contact pressure applied thereto and the haptic feedback actuator 50 causing the display panel 22 to vibrate.

The actuator 30 may be configured as a piezo actuator or a polymer actuator. The actuator 30 may generate vibrations in order that a user may be provided with different types of haptic feedback according to a change in contact pressure with the display panel 22.

The magnitude of vibrations (vibration intensity) and the number of vibrations (amount of vibrations, vibration frequency) of the actuator 30 may be determined by a controller (not shown) provided on the circuit board. At this time, the controller may control a change in the application of voltage in such a manner as to make variations in the magnitude of vibrations and the number of vibrations.

The actuator 30 may be a bar-shaped ceramic stacked body including ceramic layers and an electrode interposed between the ceramic layers, and polarizations of the ceramic layers may be formed in the same direction.

The actuator 30 is fixedly adhered to the support plate 40 in a manner such that an adhesive is applied to a lower surface of the actuator 30 to be thereby adhered to the support plate 40.

At this time, the adhesive may have high adhesive strength in order to allow the actuator 30 to be steadily fixed to the support plate 40. For example, a thermosetting adhesive capable of maintaining variation rigidity while having high adhesive strength may be used.

In the present embodiment, only the adhesion of the actuator 30 and the support plate 40 is described. However, the invention is not limited thereto. An adhesive may also be applied between the actuator 30 and the display panel 22 so that they can be adhered to each other.

At this time, the adhesive may allow for the transfer of the vibrations generated in the actuator 30 to the display panel 22. For example, an anaerobic adhesive such as a UV adhesive may be used.

Herein, the actuator 30 has elasticity in a lengthwise direction thereof, while the support plate 40 is formed of a material unable to change in length. For this reason, the actuator 30 vibrates vertically in a thickness direction thereof, rather than in a direction of the elasticity thereof.

Therefore, since the actuator 30 vibrates vertically in the thickness direction thereof, greater vibratory force may be transferred to the display panel 22 as compared with a case in which the actuator 30 vibrates in the lengthwise direction thereof.

The actuator 30 may include four bar-shaped piezoelectric elements disposed on the support plate 40. The respective bar-shaped piezoelectric elements may be arranged to have one end towards a central portion of the support plate 40 and the other end towards respective corners of the support plate 40. That is, the four bar-shaped piezoelectric elements may be arranged to radiate outwardly from the central portion of the support plate 40 towards the respective corners thereof.

Since those piezoelectric elements are longer than those used in the case in which the piezoelectric elements are arranged in a row on the sides of the support plate 40 in a lengthwise or widthwise direction thereof, the vibration intensity of the actuator 30 becomes greater.

Slits 42 may be formed to penetrate the support plate 40 in a thickness direction thereof. The respective slits 42 may be arranged to have one end towards the central portion of the support plate 40 and the other end towards the respective sides of the support plate 40.

The slits 42 are intended to divide the support plate 40 into vibration areas corresponding to the actuator 30. In the present embodiment, each of the slits 42 may be arranged between adjacent piezoelectric elements among the four piezoelectric elements.

That is, the four slits 42 may be respectively formed between among the four piezoelectric elements. The slits 42 may be formed by etching the support plate 40.

The support plate 40 may be divided into four areas by the slits 42. In this manner, such a division may minimize the influence of the vibrations generated by one piezoelectric element on the area corresponding to another piezoelectric element.

Meanwhile, the length of the actuator 30 or the arrangement thereof on the haptic device 20 becomes a main factor in the vibration characteristics of the haptic device 20.

As described in the present embodiment, in the case that the support plate 40 is divided into four areas by the slits 42 and four piezoelectric elements are arranged to traverse the respective areas, each of the piezoelectric elements is increased in length so that the amount of vibrations thereof increases, and the vibrations generated thereby are dispersed to a wider range of area, whereby uniform haptic feedback can be provided.

Meanwhile, in the present embodiment, the direct transfer of the vibrations generated in the actuator 30 to the display panel 22 is described. However, the invention is not limited thereto. A vibration plate may be interposed between the display panel 22 and the actuator 30 in order to amplify vibrations or alleviate an impact with respect to vibrations in the transfer of the vibrations to the display panel 22.

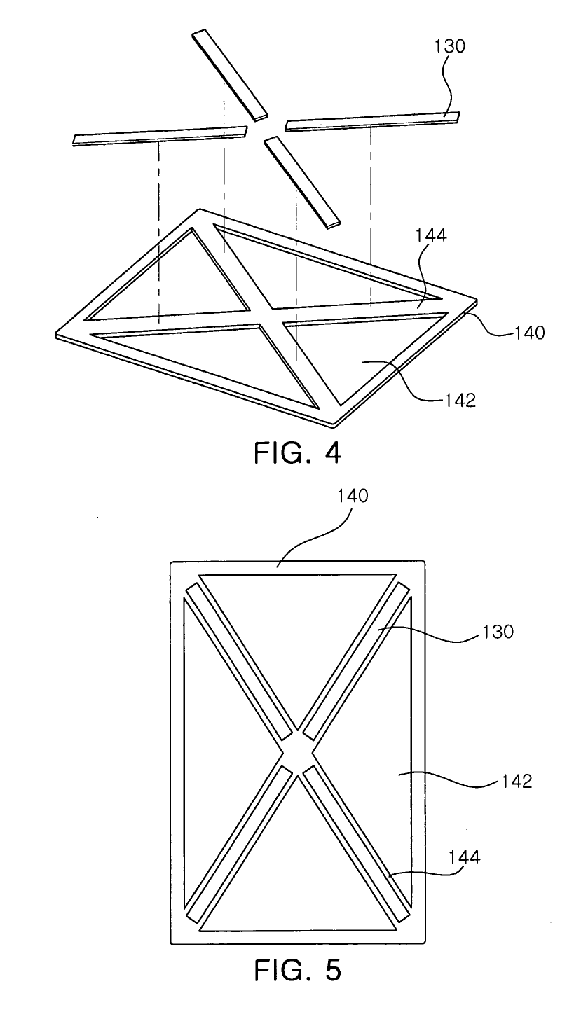

FIG. 4 is an enlarged exploded view of a haptic feedback actuator according to another exemplary embodiment of the present invention. FIG. 5 is a plan view of a haptic feedback actuator according to another exemplary embodiment of the present invention.

In a haptic feedback actuator according to another exemplary embodiment of the invention illustrated in FIGS. 4 and 5, a support plate is configured as a rectangular frame including diagonal branch lines and an actuator is adhered to the branch lines. With the exception of these features, this haptic feedback actuator is substantially the same as that illustrated in FIG. 2, so a detailed description thereof will be omitted. Hereinafter, different features will be described in detail.

With reference to FIGS. 4 and 5, the haptic feedback actuator according to the present embodiment may include a support plate 140 configured as a rectangular frame including diagonal branch lines 144 connecting diagonally opposed corners of the rectangular frame.

An actuator 130 may be adhered to the branch line 144, and the division of vibration areas corresponding to the actuator 130 may be made by opening portions 142 provided between the branch lines 144.

That is, the opening portion 142 may be a triangular section having each side of the rectangular frame as a bottom side thereof and having a point where two diagonal branch lines 144 meet as the apex thereof.

The width of the branch lines 144 may be equal to or greater than that of the actuator 130 in order that the actuator 130 may be supported thereby.

As set forth above, a haptic feedback actuator, a haptic feedback device and an electronic device according to exemplary embodiments of the invention can enable a user to have uniform haptic feedback on the entirety of a touch panel.

Also, since an actuator has increased in length as compared with a case in which an actuator is arranged in both sides of a plate, high vibration intensity is obtained.

While the present invention has been shown and described in connection with the exemplary embodiments, it will be apparent to those skilled in the art that modifications and variations can be made without departing from the spirit and scope of the invention as defined by the appended claims.

What is claimed is:

1. A haptic feedback actuator comprising:
a support plate disposed in a lower portion of a haptic device;
one or more actuators disposed on the support plate, each having one end towards a central portion of the support plate and the other end towards a corner of the support plate, and generating vibrations so as to give different types of haptic feedback according to a change in contact pressure applied to the haptic device; and
one or more dividing portions, each penetrating the support plate in a thickness direction thereof and dividing the support plate into vibration areas corresponding to the respective actuators.

2. The haptic feedback actuator of claim 1, wherein the one or more dividing portions are configured as slits, each having one end towards the central portion of the support plate and the other end towards a side of the support plate.

3. The haptic feedback actuator of claim 1, wherein the support plate is configured as a rectangular frame including diagonal branch lines, and
the one or more actuators are adhered to the branch lines.

4. The haptic feedback actuator of claim 3, wherein the one or more dividing portions are opening portions between the branch lines.

5. The haptic feedback actuator of claim 1, wherein the one or more actuators are piezo actuators, each being configured as a bar-shaped ceramic stacked body including ceramic layers and an electrode interposed between the ceramic layers.

6. A haptic feedback device comprising:
a display panel provided as a haptic device in which vibrations are required;
a support plate disposed in a lower portion of the display panel;
one or more actuators disposed on the support plate, each having one end towards a central portion of the support plate and the other end towards a corner of the support plate, and generating vibrations so as to give different types of haptic feedback according to a change in contact pressure applied to the display panel; and
one or more dividing portions, each penetrating the support plate in a thickness direction thereof and dividing the support plate into vibration areas corresponding to the respective actuators.

7. The haptic feedback device of claim 6, wherein the one or more dividing portions are configured as slits, each having one end towards the central portion of the support plate and the other end towards a side of the support plate.

8. The haptic feedback device of claim 6, wherein the support plate is configured as a rectangular frame including diagonal branch lines, and
the one or more actuators are adhered to the branch lines.

9. The haptic feedback device of claim 8, wherein the one or more dividing portions are opening portions between the branch lines.

10. The haptic feedback device of claim 6, wherein the one or more actuators are piezo actuators, each being configured as a bar-shaped ceramic stacked body including ceramic layers and an electrode interposed between the ceramic layers.

11. The haptic feedback device of claim 6, further comprising a vibration plate disposed between the display panel and the one or more actuators and amplifying the vibrations generated in the one or more actuators to thereby transfer the amplified vibrations to the display panel.

12. An electronic device comprising:
a case having an internal space formed therein;
a display panel accommodated to be disposed within the case;
a support plate disposed in a lower portion of the display panel;
one or more actuators disposed on the support plate, each having one end towards a central portion of the support plate and the other end towards a corner of the support plate, and generating vibrations so as to give different types of haptic feedback according to a change in contact pressure applied to the display panel; and
one or more slits, each penetrating the support plate in a thickness direction thereof and having one end towards the central portion of the support plate and the other end towards a side of the support plate in order to divide the support plate into vibration areas corresponding to the respective actuators.

13. The electronic device of claim 12, wherein the one or more actuators are piezo actuators, each being configured as a bar-shaped ceramic stacked body including ceramic layers and an electrode interposed between the ceramic layers.

14. The electronic device of claim 12, further comprising a vibration plate disposed between the display panel and the one or more actuators and amplifying the vibrations generated in the one or more actuators to thereby transfer the amplified vibrations to the display panel.
